(19) United States
(12) Patent Application Publication
(10) Pub. No.: US 2006/0124075 A1
(43) Pub. Date: Jun. 15, 2006

(54) Apparatus and method for pet grooming and housekeeping

(76) Inventor: Evan Matsumoto, Seattle, WA (US)

Correspondence Address: Evan Matsumoto, 14407 - 2nd Ave S.W., Seattle, WA, 98116, US

(21) Appl. No.: 11/298,860

(22) Filed: Dec. 9, 2005

Related U.S. Application Data
(60) Provisional application No. 60/636,443, filed on Dec. 15, 2004.

(51) Int. Cl. A01K 13/00

(52) U.S. Cl. 119/601

(57) ABSTRACT

A pet grooming system consisting of a hidden vacuum cleaner, a wet/dry debris collection means, a long hose, and a specialized grooming brush, and sound absorbing quality of the collection means and the hoses. Cats and dogs can be easily trained to accept brushing with a vacuum hair collection system if it runs silently.

### RELATED APPLICATION

Provisional application No. 60/636,443 Filed on Dec. 15, 2004 and titled Apparatus and Method for Pet Grooming and Housekeeping.

### U.S. GOVERNMENT INTEREST IN THE INVENTION

None

### BACKGROUND OF THE INVENTION

1. Field of the Invention

Pet grooming and housekeeping with pets, in particular cats, dogs, and horses using suction devices to clear away hair and dander.

2. Description of Related Art

Many individual grooming components such as brushes, combs, and lint or hair pick devices both with and without the aid of vacuum debris removal are available in the art. It is well known that pets, cats in particular, have aversions to noise, in particular the roar and hissing sounds from a vacuum cleaner. This includes both the floor unit and the hose attachment. There is more tolerance to “built-in” vacuum cleaners because the motor unit is usually far away and does not move or approach the animals.

U.S. Pat. No. 3,955,238 by Jerry Reijas teaches the use of a long hose to enable the power unit (noise source) to be hidden away from the pet being groomed. Reijas does not teach anything about muffling the sound conducted through the hose, nor using an intermediate hair/dirt collection pot.

U.S. Pat. No. 5,647,091 by Brian DeBlois, et al, teaches the use of a noise reducing muffler in the exhaust circuit and surrounding the motor itself. They do not indicate that noise reduction may be a characteristic of either the hose or the dirt collection system. No noise muffling elements are placed between the fan and hose or brush head. '091 uses a conventional bag for dirt collection, not a cyclonic separating chamber. '091 is carefully designed as a stand-alone grooming system with the machinery to be located in close proximity to the animal. The designers even considered the size and shape of the vacuum machine to minimize the fear-inducing characteristics of the machine itself. The '091 system does not include pet related housekeeping accessories or clean-up functions.

The present invention is a system that includes fan-noise muffler means in the hose circuit, and a training method for convincing a reluctant pet to stand for grooming with a brush on a vacuum hose. The system also has components specifically designed to clean up “accidents” and other leavings of a pet, and to open drains clogged by hair from bathing a pet such as a long haired dog.

Many patents were reviewed for relevant prior art. None were found that taught a method of training an animal to stand for grooming with a vacuum hose/brush system. None were found that had an in-line (hose-line) cyclonic separator or an in-line mufflers, and certainly not combined cyclonic separator and muffler.

### OBJECTS OF THE INVENTION

It is an object of the invention to train a fur bearing animal pet to accept being brushed with a brush attached to a vacuum cleaning system.

It is another object of the invention to have the proper tools and methods to clean up after a pet.

It is another object of the invention to have the proper tools to unclog a drain stopped with pet hair.

### BRIEF SUMMARY OF THE INVENTION

A pet care system described as comprising:

A suitable high volume low pressure vacuum generating machine, and a long flexible first hose connected to a hair, particulate, and water collection trap and, a flexible second hose having one end connected to said collection trap and the other end connected to a specialized brush for brushing an animal. The brush is adapted to remove loose hair, dander, dirt, fleas, and other debris entrapped in an animal's fur without undue hair pulling or scratching.

The key to success for the present invention is the sound muffling characteristics of the corrugated hoses and the wet/dry debris collection unit. Together these absorb the roar coming through the vacuum hose from the fans in the vacuum producing machine. Noise directly from the machine is minimized by placing the machine at minimum around a corner, but preferably in another room with the door closed against the hose, or better, utilizing a “built-in” power vacuum module which is usually located in the basement of a home.

Other specialized tools for picking up lint, washwater and soil, and applying suction to a drain are included as part of the pet grooming system.

### BRIEF DESCRIPTION OF THE FIGURES

FIG. 1 is an overall view of the invention set up for grooming a pet

FIG. 2 is an overall view of the wet/dry hair and dirt collector

FIG. 3 is a view of the preferred pet brush

FIG. 4 is a view of the drain unclogger attachment

FIG. 5 is a view of a pet/furniture/clothing brush

FIG. 6 is a view of an optional cone shaped dirt from air separating means

FIG. 7 is a view of a wet/dry clean-up attachment.

FIG. 8 is a cross section view of a typical corrugated hose.

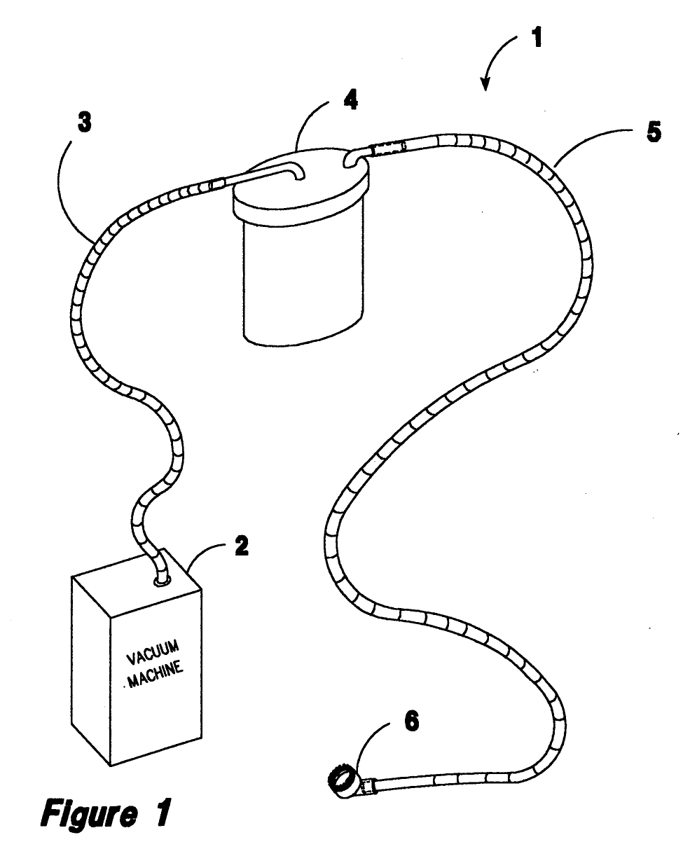

TABLE OF IDENTIFIED DETAILS

| | |
|---|---|
| 1. | Pet grooming system |
| 2. | Vacuum source |
| 3. | Intermediate hose |
| 4. | Wet/dry collection bucket |
| 5. | Long hose |
| 6. | Pet grooming brush |
| 7. | Hose connection |
| 8. | Brush body |
| 9 | Brush or comb tines |
| 10. | Collection bucket |
| 11. | Bucket lid |
| 12. | Inlet connection port |
| 13. | Outlet connection port |
| 14. | Separation cone device |
| 15. | Conical surface |
| 16. | Opening cut into cone |
| 17. | Drain cleaning adapter |
| 18. | Outlet connection port |
| 19. | Tub drain sealing opening |
| 20. | Lint brush assembly |
| 21. | “One way” fabric brush element |
| 22. | Breathing holes |
| 23 | Exhaust port |
| 24. | Outlet connection port |
| 25. | Wet/dry clean up attachment tool |
| 26. | Hose connection port |
| 27. | Working end of wet/dry attachment tool |
| 28. | Corrugated hose ridge |
| 29. | Corrugated hose valley |

A & B shows the direction of useful motion

### DETAILED DESCRIPTION OF THE INVENTION

Referring to the figures; the pet grooming assembly 1 comprising a suction machine 2 producing a static pressure of 30 to 120 inches of water, an interconnecting hose 3, a debris and water collection means 4, a long corrugated hose to isolate the working head from the suction machine, and a collection of hose-end tools, in particular a brush/comb 6 adapted to smooth an animal's coat and to whisk away loosened hair, dander, fleas, and wash water. The longer hose may be either before or after the debris collection means.

Most upright, tank, and built-in vacuum cleaners are suitable. Hose sections 3 and/or 4 are flexible corrugated hoses of 1.5 inch OD diameter, with a flex-spiral pitch of 4 turns per inch. A suitable hose can be purchased from Plastiflex Company in California. Hose section 3 connects the vacuum source 2 to the wet/dry dirt and hair collector bucket 4. Hose section 5 is at least 15 feet long and connects the collector bucket 4 to the grooming comb or brush 6.

Bucket 4 and the hose segments 3 and 5 all contribute to muffling the noise from the vacuum source 2. The hoses are constructed with corrugations in the interior wall as shown in FIG. 8. The undulating hose wall 28, 29 makes absorption channels and multiple reflections of any sound ducted along the hose, effectively absorbing such noise, and especially the high frequencies most annoying to dogs and cats. FIG. 8 depicts a hose having spiral corrugations. Ring corrugations well suffice just as well. Those may be reinforced with wire or may have the curved segments at the top and/or bottom of the corrugations thickened to provide additional strength against crushing. A total of 15 feet of corrugated hose is adequate, but minimal, to provide both sound muffling and separation of the vacuum machinery from the pet brush.

If additional muffling is needed, a sound absorbing liner can be put into the collector bucket or a specific muffler may be inserted into the hose line.

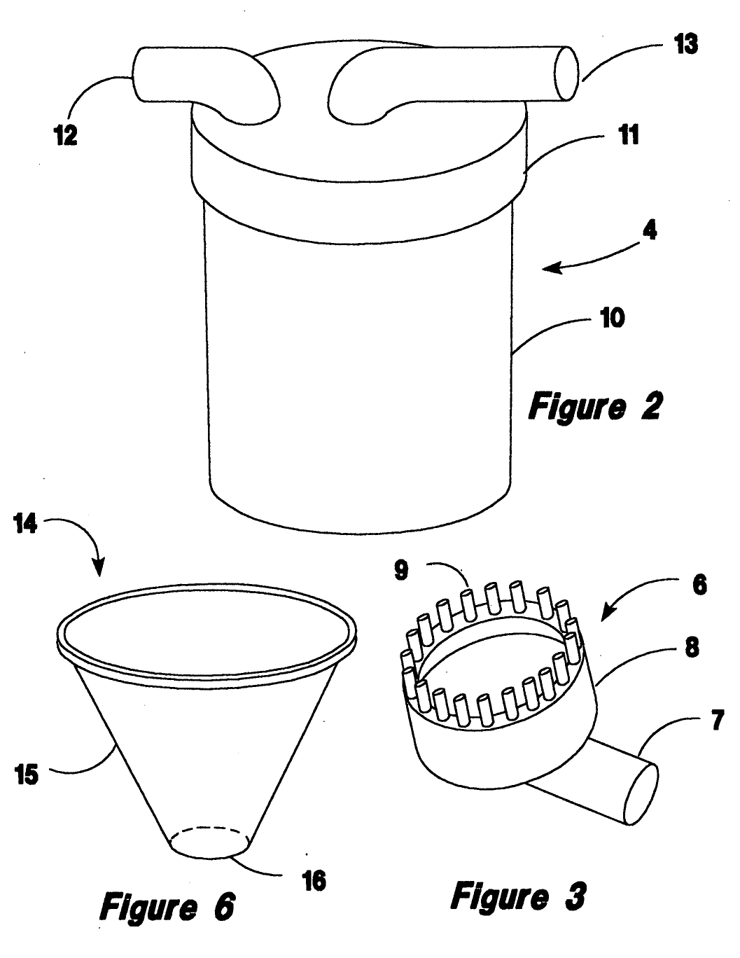

Referring to FIG. 2; the essential parts of the collection bucket 4 are the bucket 10, a removable lid assembly 11 with inlet and outlet ports 12 & 13. The input port 12 mounted at one edge of the lid. The incoming stream of air with dirt is directed downwards or tangentially. A tangential jet will cause the dirt, hair, or water laden air to rotate around the interior of the bucket and drop its load as the air spirals toward the center exhaust port. The exit port is attached to the bucket lid at approximately the center where the air exits the bucket from whence it drawn through hose 3 to the vacuum machine 2. In addition, the lid may contain a fine-dust filter and a float valve to stopper the outlet port if the bucket should become filled with water.

A unique feature of the preferred collection bucket is a float operated valve that closes off the suction when the bucket fills with water. This prevents water from being drawn into the vacuum source. The valve in the preferred bucket is a hollow ball that rises on collected water until it nears the entrance of the output tube. The flowing air finishes lifting the ball and the suction pressure pulls the ball tightly into the seat on the end of the outlet tube.

Referring to FIG. 3; brush 6 terminates in a tube 7 adapted to attach to hose 5. Brush body 8, holding bristle set 9 is usually circular, but may be oval or rectangular or minimally one row or two parallel rows of bristles. Bristles 9 are made of soft plastic or rubber and are approximately ⅛ inch diameter and ¼ to ½ inch long. The spacing between bristles permits considerable air to pass between and carry dander and loose hair into the suction hose. An advantage of this kind of brush or comb is that it is incapable of scratching the pet's skin, is easily cleaned by hand, and may be washed with soap and water.

The cone 14 shown in FIG. 6 is an optional conical dirt separator. A cone is more effective in separating dirt and water droplets from the air stream than the bucket alone. The dirt falls through the open end 16 of the conical frustum and into the bottom of the bucket 10. The cone surface 15 also serves to shield the collected dirt from being stirred up by the air stream jetted from the input port. A paper or plastic bag may be used to line the bucket to make emptying easier. A paper bag works best in conjunction with the separation cone. Also, paper holds itself in place better than the usual thin, limp plastic bag material.

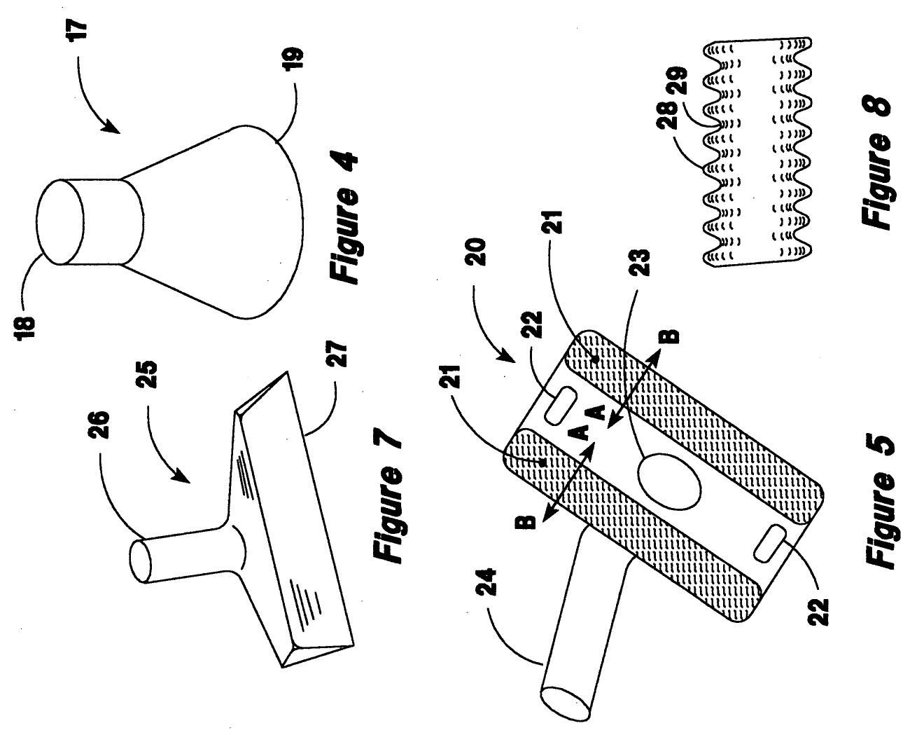

The attachment 17 shown in FIG. 4 is an adapter to apply suction to the drain opening in the bottom of a sink, bath tub, or laundry tub. The vacuum hose is attached to end 18, and the large end 19 is placed over the drain. The attachment is made of flexible material or has a flexible rim on end 18 to conform to the tub to make an air tight seal. If a better seal is needed, the bottom of the tub is filled with an inch or so of water. When the vacuum is applied, the water in the P trap is drawn out with considerable velocity, drawing the plugging mass with it. It is sometimes necessary to re-fill the P trap and re-apply the suction several times before the plug is dislodged.

The brush attachment 20 shown in FIG. 5 is designed to dislodge hair and lint from pets, furniture, and clothing. The hose is attached at the attachment end 24. Brush elements 21 are velvet like material characterized by a nap that is smooth when stroked one direction, and prickly when stroked in the opposite direction. The prickly direction is when a brush element is moved over furniture in the direction from A to B, that is, away from the interior of the brush. This direction scrapes up lint and rolls it into ropes, then when the brush element is moved the opposite direction, the lint is released and rolled into the central section where air is moving from holes 22 toward the outlet 23, thence out of the attachment 20 through tube 5.

The wet/dry pickup 25 shown in FIG. 7 expands the terminal end of the hose into an elongated opening 27 without bristles or comb teeth. The hose attaches to the hose adapter 26. The working end 27 is plain with no edge teeth or bristles.

This tool is particularly good for picking up wet stuff from both hard surfaces and carpets. It forms an effective seal at the edges causing air to be drawn through a carpet or upholstery.

It works similarly on an animal, but does not pull the skin as does the bare end of the hose.

### HOW TO USE THE INVENTION

The invention may be used to brush an animal, such as a dog, cat, horse, or other, before or after bathing. The grooming system will pull loose water from the animal's fur and speed drying. In the case of use on a horse, it can be used to remove sweat and lather without making a mess on the floor or using as many towels.

In most cases, a cat or dog needs to be trained to accept brushing with the accompanying strange sensations of the noise and air flow. Because the system reduces the machinery noise considerably, the training has a high success rate. Cats have been known even to enjoy having their tails drawn into the open hose end.

The preferred training process is comprising some or all of the actions from the the following steps:

1. Place the suction machine in another room or at least out of sight of the pet.

2. With the suction machine turned OFF, gently brush the pet as long as the pet will tolerate it or until acceptance.

3. Repeat step 2 until the pet accepts the presence of the hose and being brushed.

4. With the suction hose disconnected, turn on the suction machine. It is preferable to have someone else turn the machine on so that brushing is not interrupted.

5. When the pet is no longer alarmed by the machine noise coming from the next room, connect the suction hose.

6. Brush the pet with the suction applied on parts of the body which have been discovered to be the least objectionable. AVOID the EARS, FACE, NECK, PAWS, and other parts where the animal has shown or is expected to show reluctance to being touched or brushed.

7. When finished with a dry brushing session, place or draw a mothball into the bucket and leave at least 1 hour to kill any trapped fleas and ticks.

Stop any training session when the animal shows fear or struggles or attempts to escape.

Use short sessions. Most pets, especially cats, quickly tire of being handled.

Never chase or tease the animal with the vacuum cleaner machine or the hose.

I claim:

1. A process for training an animal to tolerate being groomed by a grooming tool containing air flowing therethrough under the influence of a suction machine and a hose operably connecting the grooming tool and suction machine; comprising the steps of:
a. Placing the suction machine at a distance from the animal; and
b. setting the suction machine into a non-functioning mode and gently grooming the animal; and
c. repeating step 2 until the pet accepts the presence of the hose and being groomed with the grooming tool; and
d. setting suction machine into a functioning mode and grooming the animal; and
e. stopping any training session then the animal displays fear or attempts to escape; and
f. repeating steps a through e until the animal accepts being groomed with said suction machine in the function mode.

2. The process steps of claim 1 where placing the suction at a distance is placing the suction machine in another room away from the animal.

3. The process steps of claim 1 further comprising steps intermediate between steps c and d:
c1. disconnecting the hose from the suction machine and setting the suction machine into a functioning mode; and
c2. grooming the animal until acceptance of the sound of the suction machine.

4. A system for grooming an animal comprising:
a. in combination, a first flexible hose interconnecting a suction machine and a debris collection means, a second flexible hose interconnecting said debris collection means and a removably attached grooming tool adapted for grooming an animal; and
b. where said second hose is at least 15 feet long; and corrugated to provide absorption of sound traversing said second hose.

5. The grooming system of claim 4 where said sound absorbtion is a characteristic of the debris collection means.

6. The grooming system of claim 4 further including a removably attachable tool adapted for providing suction on a drain.

7. The grooming system of claim 4 further including a removably attachable tool adapted for drawing liquids from a surface.

8. The grooming system of claim 4 further including a removably attachable tool adapted to roll lint into ropes then present said ropes to the suction in said second hose for being whisked away.
